(19) United States
(12) Patent Application Publication
(10) Pub. No.: US 2009/0314140 A1
(43) Pub. Date: Dec. 24, 2009

(54) PORTABLE SLEEVE ABUTMENT STRUCTURE

(76) Inventor: Chiao-Ling LU, Changhua City (TW)

Correspondence Address: EGBERT LAW OFFICES, 412 MAIN STREET, 7TH FLOOR, HOUSTON, TX, 77002, US

(21) Appl. No.: 12/144,540

(22) Filed: Jun. 23, 2008

(51) Int. Cl. B25G 1/08

(52) U.S. Cl. 81/177.4

(57) ABSTRACT

The present invention provides a portable sleeve abutment structure. A locating seat is arranged at one end of the sleeve abutment body. The locating seat is provided with an assembled locating portion for mating with the tool. The sleeve abutment body is provided with through-type hold tank, which could penetrate through the sleeve abutment body, and define two spaced end walls as well as two side walls. An end wall of the hold tank is provided with a locating column, which has a blocky portion. The blocky portion is diametrically mated with the square hole of the sleeve onto the hold tank. Two side walls of the hold tank are provided with spaced lateral locating flanges. It is possible to take out or place sleeves from both directions of the portable sleeve abutment in a more flexible and convenient manner.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a portable sleeve abutment, and more particularly to an innovative sleeve abutment structure with a sleeve locating slot permitting bidirectional take-out and placement by combining a spherical column with bidirectional snap locks at both ends.

2. Description of Related Art Including Information Disclosed Under 37 CFR 1.97 and 37 CFR 1.98.

The portable sleeve abutment of the present invention is generally assembled into a slot preset within the handle, so as to enhance the dimensional compactness and make it easier for carrying.

In line with the number of sleeves, the portable sleeve abutment is generally provided with several sleeve locating slots. The typical sleeve locating slot generally has a lateral grooved space for mating with the sleeve. A retaining surface is formed within the grooved space and a snap lock formed at both sides of the grooved space. So, the sleeve must be placed into the open end of the grooved space and then positioned fixedly. To take out the sleeve more conveniently, the retaining surface of the grooved space is provided with a through-hole, enabling the operator to insert fingers to push out the sleeve in reverse. However, the following shortcomings are observed during actual applications due to directional limitations of the sleeve.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based upon the innovative present invention, the sleeve abutment body is provided with a through-type hold tank. A locating column is arranged onto an end wall of the hold tank. Two side walls are provided with lateral locating flange. The operator can take out or place the sleeves from both directions of the sleeve abutment body in a more flexible and convenient manner.

There are improvements brought about by this invention.

Based upon the structures of the present invention, the locating seat is coupled with the sleeve abutment body. A magnetic body is assembled at one end of the sleeve abutment body, and the sleeve abutment body is adsorbed and positioned onto the magnetic or conductive object, thus enabling the operator to use the sleeve more easily and conveniently.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts an exploded perspective view of portable sleeve abutment and tool of the present invention.

FIG. 2 depicts a partially enlarged perspective view of portable sleeve abutment of the present invention.

FIG. 3 depicts a partial sectional view of portable sleeve abutment and tool of the present invention.

FIG. 4 depicts a sectional view of the present invention for insertion of big and small sleeves into the hold tank.

FIG. 5 depicts a sectional view of the present invention, showing a single sleeve inserted into the hold tank.

FIG. 6 depicts another sectional view of an application of a blocky portion of the locating column of the present invention.

FIG. 7 depicts a sectional view of another application view of the blocky portion of the locating column of the present invention.

FIG. 8 depicts a sectional view of the operation of the bidirectional sleeve of the present invention.

FIG. 9 depicts another sectional view ofan application of the present invention with the sleeve abutment body adsorbed onto the object.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

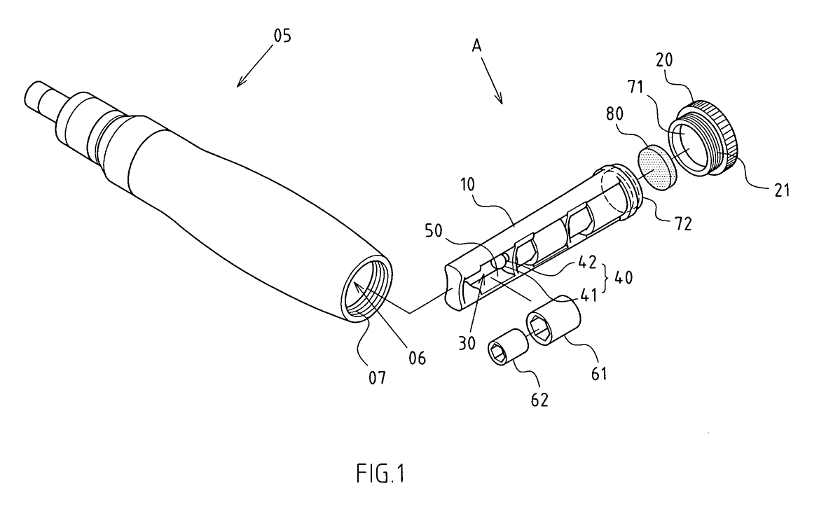

FIGS. 1-3 depict preferred embodiments of portable sleeve abutment structure of the present invention. The embodiments are provided for only explanatory purposes with respect to the patent claims.

The portable sleeve abutment A comprises a sleeve abutment body 10 of predefined width, thickness and length. For example, the sleeve abutment body 10 of the present invention has a tapered long block.

A locating seat 20 is mated with or integrally assembled onto one end of the sleeve abutment body 10. The locating seat 20 is provided with an assembled locating portion 21, allowing for positioning onto the preset tool 05, such as a ratcheting device in a preferred embodiment. The assembled locating portion 21 of the locating seat 20 is comprised of external threads, enabling the threads to be screwed onto the female thread 07 preset at one end of a hold tank 06 of the tool 05.

A through-type hold tank 30 is assembled into the sleeve abutment body 10 for accommodating the sleeves 61, 62. The hold tank penetrates through the sleeve abutment body and defines two spaced end walls 31, 32 as well as two side walls 33. The hold tank 30 of the present invention forms a space of a flexible diameter, thus forming big and small sleeve holding portions 34, 35, and also placing big and small sleeves 61, 62 simultaneously into the single hold tank 30.

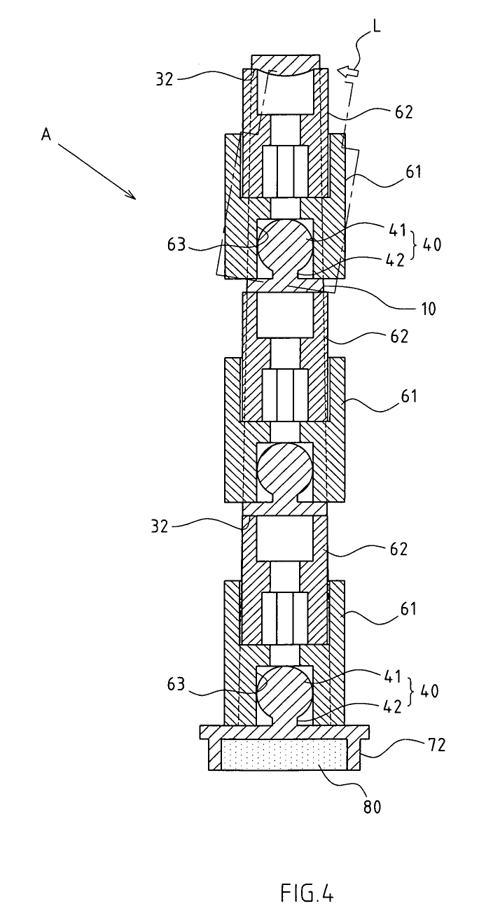

A locating column 40 is assembled onto an end wall 31 of the hold tank 30. The locating column 40 comprises a blocky portion 41 and a reducing connection column 42. The connection column 42 is used to connect the blocky portion 41 and end wall 31 of the hold tank 30. Moreover, the blocky portion 41 is diametrically mated with the square hole 63 at one end of the expanded sleeve 61 onto the hold tank 30 (shown in FIG. 4).

A lateral locating flange 50 is assembled opposite to two side walls 33 of the hold tank 30. The lateral locating flange 50 has two recessed profiles, which are set in arched or curved shapes. When the sleeves 61, 62 are placed from both ends of the hold tank 30, the sleeves 61, 62 are adapted with the lateral locating flange 50 for positioning purposes.

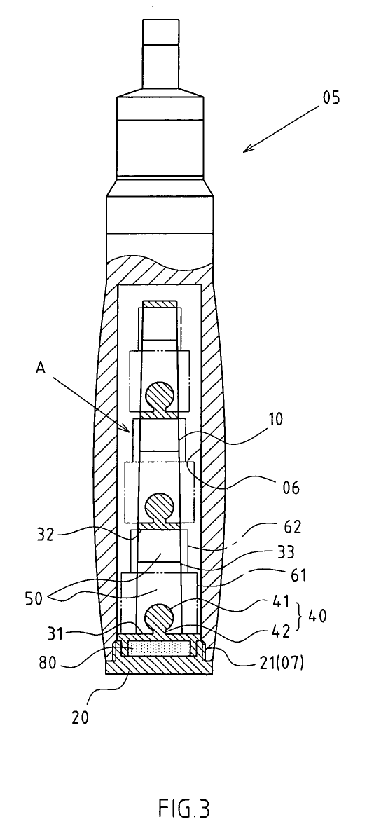

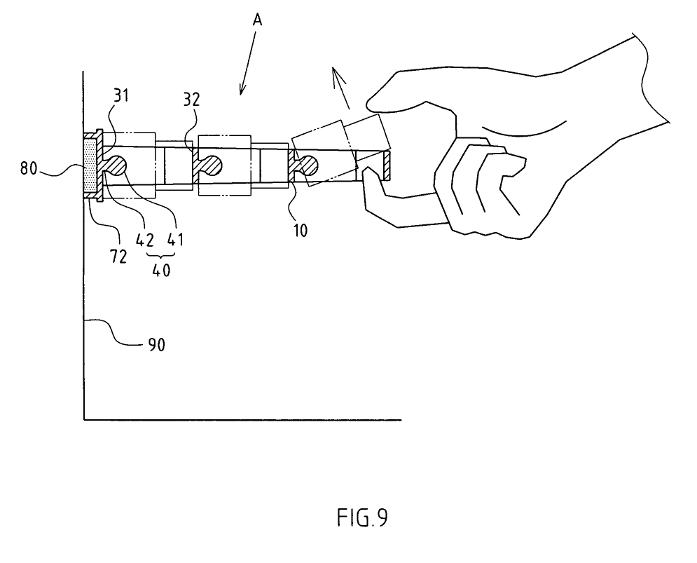

Referring to FIGS. 1 and 3, the locating seat 20 and sleeve abutment body 10 are coupled through a positioning structure, which is of a notch 71 or a bulge 72. Moreover, a magnetic body 80 is assembled at one end of the sleeve abutment body 10. As shown in FIG. 9, the sleeve abutment body 10 could be adsorbed and positioned onto the magnetic or conductive object 90 (e.g. metal cabinet or metal housing of mechanical device) for easy operation.

Based upon the above-specified structures, the present invention is operated as follows:

Referring to FIG. 3, the portable sleeve abutment A can be assembled into the hold tank 06 of the preset tool 05 (e.g. ratcheting device), allowing it to be carried and retracted along with the tool 05.

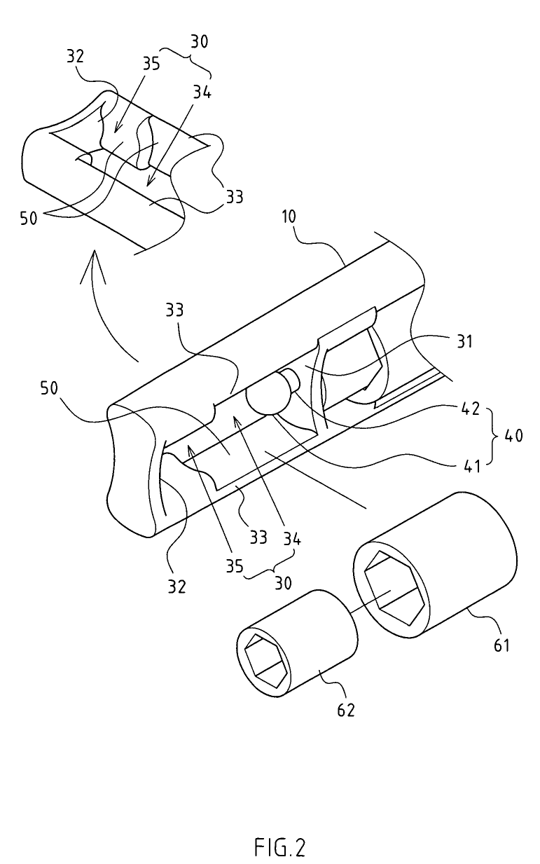

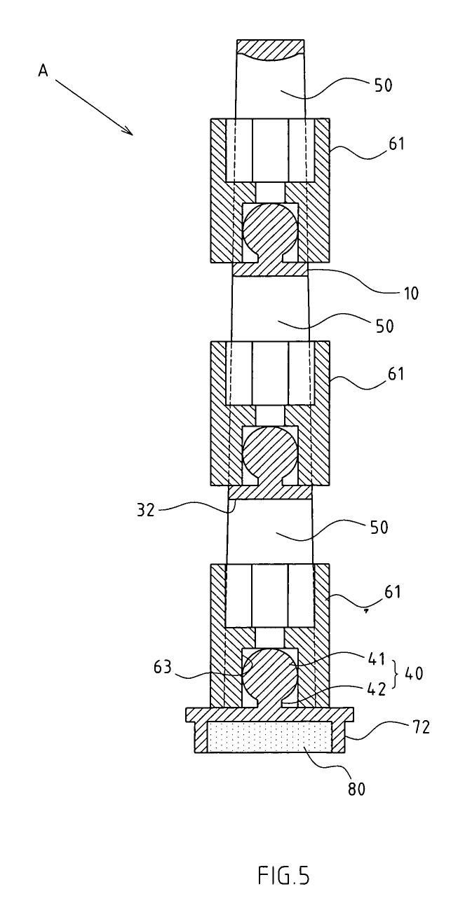

Referring to FIGS. 1 and 2, the hold tank 30 is a space with big and small sleeve holding portions 34, 35, so that two sleeves 61, 62 can be inserted into a single hold tank 30 simultaneously. Referring to FIG. 4, two sleeves 61, 62 are firstly interpolated together. When the sleeves 61, 62 are to be inserted, the big sleeve 61 is first sleeved onto the locating column 40 at one end of the hold tank 30. In this process, the big sleeve 61 slides into the blocky portion 41 of locating column 40 from the square hole 63 Next, the small sleeve 62 is pushed into the hold tank 30, as shown by arrow L in FIG. 4. Meanwhile, the sleeves 61, 62 are locked and limited through two lateral locating flanges 50, thereby realizing their positioning state. Referring also to FIG. 5, the hold tank 30 can also accommodate a single sleeve 61 or 62, which is positioned securely through the locating column 40 and lateral locating flange 50. A big sleeve is shown in this preferred embodiment.

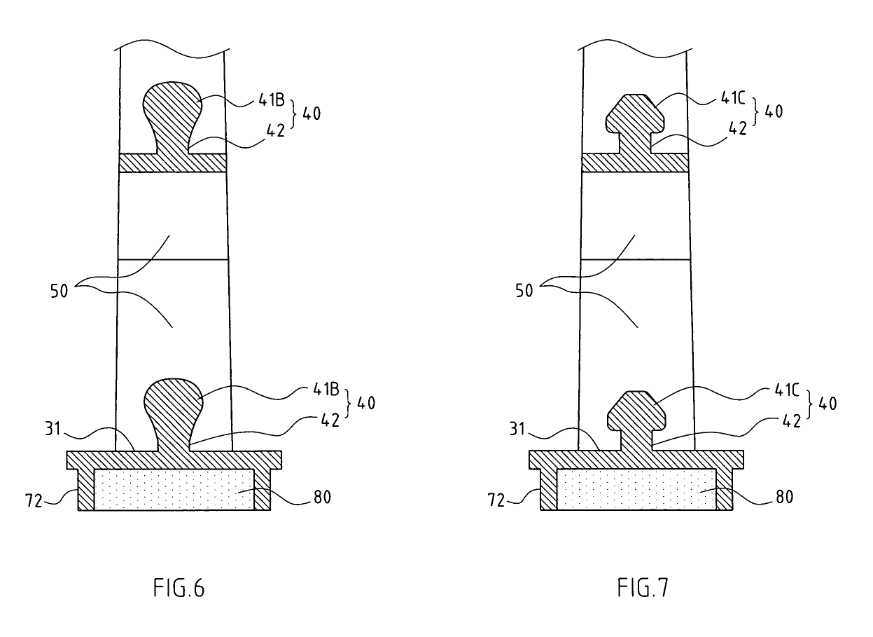

Referring to FIGS. 1-5, the blocky portion 41 of the locating column 40 has a spherical shape. Referring to FIG. 6, the blocky portion 41B has a teardrop shape. Referring also to FIG. 7, the blocky portion 41C has a tapered shape.

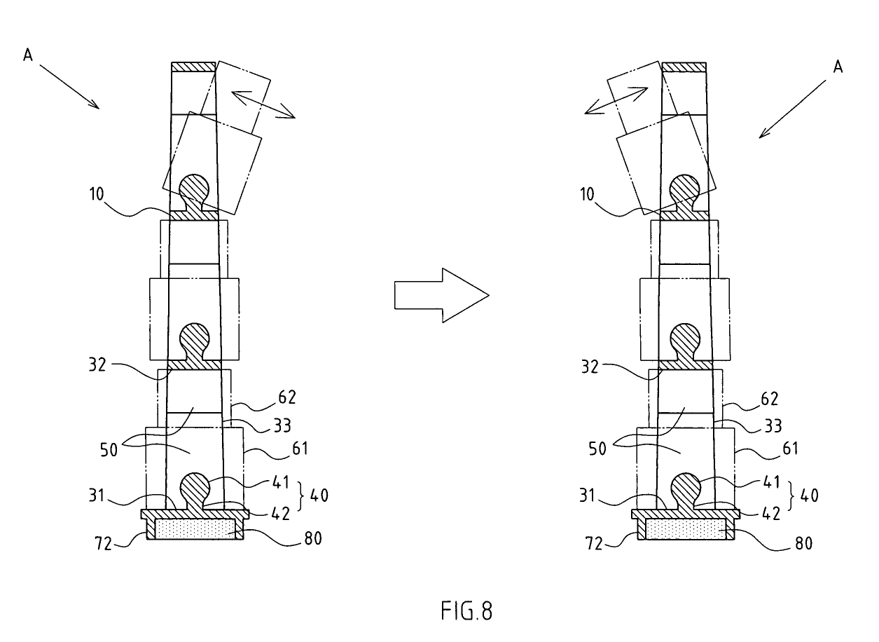

Referring to FIG. 8, the sleeve abutment body 10 of the present invention is provided with a through-type hold tank 30. A locating column 40 is arranged onto an end wall 31 of the hold tank 30. Two side walls 33 are provided with lateral locating flange 50, so the operator removes or places sleeves 61, 62 from both directions of the sleeve abutment body 10 in a more flexible and convenient manner.

1. A portable sleeve abutment structure, comprising:
a sleeve abutment body having predefined width, thickness and length;
a locating seat, being mated with or integrally assembled onto one end of the sleeve abutment body; said locating seat having an assembled locating portion;
a through-type hold tank, assembled into the sleeve abutment body for accommodating sleeves, the hold tank penetrating through said sleeve abutment body, and defining two spaced end walls as well as two side walls;
a locating column, assembled onto an end wall of the hold tank, said locating column comprising a blocky portion and a reducing connection column, said connection column connecting said blocky portion and an end wall, said blocky portion being diametrically mated with a square hole at one end of a sleeve onto the hold tank; and
a lateral locating flange, assembled opposite two side walls of the hold tank.

2. The sleeve abutment structure defined in claim 1, wherein said assembled locating portion of said locating seat is comprised of external threads.

3. The sleeve abutment structure defined in claim 1, wherein said locating seat and said sleeve abutment body are coupled through a positioning structure, one end of said sleeve abutment body having a magnetic body assembled thereon, said sleeve abutment body being adsorbed and positioned onto said magnetic body.

4. The sleeve abutment structure defined in claim 3, wherein said positioning structure for said locating seat and sleeve abutment body is a notch or bulge.

5. The sleeve abutment structure defined in claim 1, wherein said lateral locating flange has two recessed profiles, being set in arched or curved shapes.

6. The sleeve abutment structure defined in claim 1, wherein the hold tank is fits into a space of flexible diameter, forming holding portions of different sizes.

7. The sleeve abutment structure defined in claim 1, wherein said blocky portion of the locating column has a spherical, a teardrop or a tapered shape.
